(19) United States
(12) Patent Application Publication
(10) Pub. No.: US 2004/0146190 A1
(43) Pub. Date: Jul. 29, 2004

(54) Medical image processing system

(75) Inventor: Satoshi Kasai, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/752,169

(22) Filed: Jan. 5, 2004

(30) Foreign Application Priority Data
Jan. 23, 2003 (JP) PATENT2003-014663

(51) Int. Cl. G06K 9/00

(52) U.S. Cl. 382/128

(57) ABSTRACT

A medical image processing system including a medical image generating apparatus for generating medical image data of a radiographed subject; a suspicious region candidate detecting apparatus for detecting a suspicious region candidate from the generated medical image data, the detecting apparatus being connected with the generating apparatus through a communication network; a network monitoring section for monitoring a communication load of the communication network; and a time setting section for setting an image transmission time for transmitting the medical image data from the generating apparatus to the detecting apparatus on the basis of a monitoring result of the communication load. The generating apparatus transmits the medical image data to the detecting apparatus at the set image transmission time.

### BACKGROUND OF THE INVENTION

1. Field of the Invention

The present invention relates to a medical image processing system and a medical image processing method.

2. Description of Related Art

In the field of medical care, for example, a technique for obtaining digital medical image data by various medical image generating apparatuses such as a computer-aided radiographic image reading apparatus (hereinafter referred to as “computed radiography (CR)”), a nuclear magnetic resonance imaging apparatus (hereinafter referred to as “magnetic resonance imaging (MRI)”) and the like have been developed, and thereby the electronic archiving of medical images is enabled.

Then, it is generally conducted that a doctor detects the suspicious regions which look like lesion by interpreting a radiograph formed by the medical image data output on a film or a display section, and that the doctor makes a diagnosis by observing the states and the variations with time of the lesion. However, because the detection of the suspicious regions depends on the skill of the doctor who performs the interpretation of the radiograph (hereinafter referred to as a “radiograph interpreting doctor”), there is some possibility that some differences are caused in the detection results of the suspicious regions with radiograph interpreting doctors. Moreover, in case of dealing with a large quantity of medical images at a mass examination or the like, the operations of interpreting radiographs are a considerable burden for a radiograph interpreting doctor.

Accordingly, with an object of precise suspicious region detection and reduction of the burden of a radiograph interpreting doctor, a suspicious region candidate detecting apparatus called as a computer-aided diagnosis supporting apparatus (hereinafter referred to a “computed-aided diagnosis (CAD)”) for detecting the candidates of suspicious regions automatically by executing the image processing of radiographed medical images has been developed (See, for example, Japanese Patent Application Laid-Open Publication No. 2002-12985).

On the other hand, with recent development in communication techniques, it has become possible to exchange data through communication networks built between each medical care department in a hospital or between each hospital. For example, a medical image processing system capable of transmitting medical image data from the medical image generating apparatus to the suspicious region candidate detecting apparatus to execute the detection processing of suspicious region candidates has been developed.

However, because in the above-described medical image processing system, a large capacity of data such as medical image data or the like is transmitted and received between each apparatus through the communication networks, the communication loads of the networks become large in some time zones, and then a long time is sometimes needed for executing transmission and reception. Nevertheless, in the medical image processing system in earlier technology, medical image data is transmitted to the suspicious region candidate detecting apparatus immediately after the generation of the data. Consequently, the loads of the networks still more become larger, and the increase of the loads is a cause of large delay of processing of medical image data in the whole medical image processing system.

Moreover, when the interpretation of a radiograph of a medical image can be performed in a suspicious region candidate detecting apparatus, there is some possibility that the execution of the detection processing of suspicious region candidates while a radiograph interpreting doctor is interpreting a radiograph makes the operation of the interpretation of the radiograph slow to disturb the operation of the interpretation of the radiograph.

Further, when a network is constructed on the basis of an instantaneous maximum communication volume, only several to several tens % of communication capacity of the network are used in a large part of time zone. Therefore, nothing but cost to communication equipment of high capacity is required, so that it cannot be said that it is sufficient from viewpoint of making the whole network more efficient.

### SUMMARY OF THE INVENTION

An object of the present invention is to reduce the communication load of a medical image processing system, and thereby, to improve the processing efficiency of medical image data in the whole system.

In order to achieve the above-described object, according to a first aspect of the present invention, the medical image processing system comprises:

a medical image generating apparatus for generating medical image data of a radiographed subject;

a suspicious region candidate detecting apparatus for detecting a suspicious region candidate from the generated medical image data, the detecting apparatus being connected with the generating apparatus through a communication network;

a network monitoring section for monitoring a communication load of the communication network; and

a time setting section for setting an image transmission time for transmitting the medical image data from the generating apparatus to the detecting apparatus on the basis of a monitoring result of the communication load,

wherein the generating apparatus transmits the medical image data to the detecting apparatus at the set image transmission time.

Further, preferably, the time setting section sets the image transmission time in a time zone in which the communication load is small on the basis of the monitoring result of the communication load.

According to the first aspect of the present invention, the communication load of the communication network is monitored, and the image transmission time of the medical image data for transmitting from the medical image generating apparatus to the suspicious region candidate detecting apparatus is set in the time zone in which the communication load is small on the basis of the monitoring result. Consequently, the communication load of the communication network can be reduced, and thereby improvement of image processing efficiency of the medical image processing system can be achieved.

Moreover, preferably, the medical image processing system comprises a priority setting section for setting priority of transmitting the medical image data,

wherein the generating apparatus transmits the medical image data to the detecting apparatus according to the set priority at the set image transmission time.

Moreover, preferably, when the detecting apparatus has received the medical image data from the generating apparatus, the detecting apparatus starts to detect the suspicious region candidate on the received medical image data.

According to the invention, the priority of transmitting medical image data is set, and the suspicious region candidate detecting apparatus starts the detection of the suspicious region candidate when the medical image data is transmitted. Consequently, the detection result of the suspicious region candidate in the medical image data can be obtained according to the priority, and thereby, improvement of diagnosis efficiency of a radiograph interpreting doctor can be achieved.

Further, preferably, the generating apparatus transmits all the medical image data belonging to the same examination.

According to the invention, all the medical image data of the same examination is transmitted. Consequently, the detection result of the suspicious region candidate can be obtained per examination, and thereby, improvement of diagnosis efficiency of a radiograph interpreting doctor can be achieved. Moreover, the suspicious region candidate detection processing performing the comparison of the detection result of the suspicious region candidate per examination is enabled, and thereby, improvement of detection accuracy can be expected.

Moreover, preferably, the medical image processing system comprises a transmission history storage section for storing information of a transmission history when the medical image data is transmitted from the generating apparatus.

According to the invention, the information of the transmission history of the medical image data is stored. Consequently, confirmation of transmission situation of the medical image data becomes easy.

Further, preferably, an output apparatus for outputting the medical image data about which the detection of the suspicious region candidate by the detecting apparatus has ended and a detection result of the suspicious region candidate is connected to the communication network.

Moreover, preferably, the output of the medical image data by the output apparatus is any one of output for a film, output for a storage medium and display output.

According to the invention, the medical image data about which the detection of the suspicious region candidate has ended and the detection result of the suspicious region candidate are outputted to a film or a recording medium or are display-outputted by the output apparatus. Consequently, the detection result of the suspicious region candidate can be easily confirmed.

According to a second aspect of the present invention, the medical image processing system comprises:

a medical image generating apparatus for generating medical image data of a radiographed subject;

a medical image receiving apparatus for receiving the generated medical image data, the receiving apparatus being connected with the generating apparatus through a communication network;

a network monitoring section for monitoring a communication load of the communication network; and

a time setting section for setting an image transmission time for transmitting the medical image data from the generating apparatus to the receiving apparatus on the basis of a monitoring result of the communication load,

wherein the generating apparatus transmits the medical image data to the receiving apparatus at the set image transmission time.

Moreover, preferably, the time setting section sets the image transmission time in a time zone in which the communication load is small on the basis of the monitoring result of the communication load.

According to the second aspect of the present invention, the communication load of the communication network is monitored, and the image transmission time of the medical image data for transmitting from the medical image generating apparatus to the medical image receiving apparatus is set on the basis of the monitoring result. Consequently, the image transmission time can be set in the time zone in which the communication load is small, and thereby the communication load of the communication network can be reduced. Hence, improvement of image processing efficiency in the medical image processing system can be achieved.

Moreover, preferably, the medical image processing system comprises a priority setting section for setting priority of transmitting the medical image data,

wherein the generating apparatus transmits the medical image data to the receiving apparatus at the set image transmission time according to the set priority.

According to the invention, the priority of transmitting the medical image data is set. Consequently, the medical image receiving apparatus can receive the medical image data according to the priority, and thereby, improvement of image processing efficiency in the medical image processing system can be achieved.

Further, the medical image processing system preferably comprises a transmission history storage section for storing information of a transmission history when the medical image data is transmitted from the generating apparatus.

According to the invention, the information of the transmission history of the medical image data is stored. Consequently, confirmation of transmission situation of the medical image data becomes easy.

Moreover, preferably, the generating apparatus transmits all the medical image data belonging to the same examination.

According to the invention, all the medical image data of the same examination is transmitted. Consequently, the detection result of the suspicious region candidate can be obtained per examination, and thereby, improvement of diagnosis efficiency of a radiograph interpreting doctor can be achieved. Moreover, the suspicious region candidate detection processing performing the comparison of the detection result of the suspicious region candidate per examination is enabled, and thereby, improvement of detection accuracy can be expected.

Further, preferably, an output apparatus for outputting the medical image data is connected to the communication network.

Moreover, the output of the medical image data by the output apparatus is preferably any one of output for a film, output for a storage medium and display output.

According to the invention, since the medical image data is outputted to a film, a storage medium or the like or is display-outputted by the output apparatus, the medical image data can be easily confirmed.

According to a third aspect of the present invention, the medical image processing system comprises:

a medical image generating apparatus having a medical image generating section for generating medical image data of a radiographed subject, and a suspicious region candidate detecting section for detecting a suspicious region candidate from the medical image data;

a medical image receiving apparatus for receiving the medical image data about which the detection of the suspicious region candidate has ended, the receiving apparatus being connected with the generating apparatus through a communication network;

a network monitoring section for monitoring a communication load of the communication network; and

a time setting section for setting an image transmission time for transmitting the medical image data about which the detection of the suspicious region candidate by the detecting section has ended to the receiving apparatus on the basis of a monitoring result of the communication load,

wherein the generating apparatus transmits the medical image data about which the detection of the suspicious region candidate has ended to the receiving apparatus at the set image transmission time.

Further, preferably, the time setting section sets the image transmission time in a time zone in which the communication load is small on the basis of the monitoring result of the communication load.

Moreover, preferably, the detecting section starts to detect the suspicious region candidate on the medical image data immediately after the medical image data is generated.

According to the third aspect of the present invention, the suspicious region candidate is detected immediately after the medical image generating apparatus has generated the medical image data, and the communication load of the communication network is monitored to set the image transmission time of the medical image data about which the detection of the suspicious region candidate has ended on the basis of the monitoring result. Consequently, the image transmission time can be set in the time zone in which the communication load is small, and thereby, the communication load of the communication network can be reduced. Hence, improvement of image processing efficiency in the medical image processing system can be achieved.

Moreover, preferably, the medical image processing system comprises a priority setting section for setting priority of transmitting the medical image data about which the detection of the suspicious region candidate has ended,

wherein the generating apparatus transmits the medical image data to the receiving apparatus according to the set priority at the set image transmission time.

According to the invention, the priority of transmitting the medical image data is set. Consequently, the medical image receiving apparatus can receive the medical image data according to the priority, and thereby, improvement of image processing efficiency in the medical image processing system can be achieved.

Further, the medical image processing system preferably comprises a reception history storage section for storing information of a reception history when the medical image data is received from the generating apparatus.

According to the invention, the reception history of medical image data is stored. Consequently, confirmation of reception situation of the medical image data becomes easy.

Further, preferably, the generating apparatus transmits all the medical image data belonging to the same examination.

According to the invention, all the medical image data of the same examination is transmitted. Consequently, the detection result of the suspicious region candidate can be obtained per examination, and thereby, improvement of diagnosis efficiency of a radiograph interpreting doctor can be achieved. Moreover, the suspicious region candidate detection processing performing the comparison of the detection result of the suspicious region candidate per examination is enabled, and thereby, improvement of detection accuracy can be expected.

Further, preferably, an output apparatus for outputting the medical image data about which the detection of the suspicious region candidate by the suspicious region candidate detecting section has ended and a detection result of the suspicious region candidate is connected to the communication network.

Further, the output of the medical image data by the output apparatus is preferably any one of output for a film, output for a storage medium and display output.

According to the invention, the medical image data about which the detection of the suspicious region candidate has ended and the detection result of the suspicious region candidate are outputted to a film or a recording medium or are display-outputted by the output apparatus. Consequently, the detection result of the suspicious region candidate can be easily confirmed.

According to a fourth aspect of the present invention, the medical image processing system comprises:

a suspicious region candidate detecting apparatus for detecting a suspicious region candidate from medical image data of a radiographed subject;

a medical image transmitting apparatus for transmitting the medical image data of a suspicious region candidate detection object to the detecting apparatus, the transmitting apparatus being connected with the detecting apparatus through a communication network;

a network monitoring section for monitoring a communication load of the communication network; and

a time setting section for setting a detection time for detecting the suspicious region candidate from the medical image data,

wherein the detecting apparatus receives the medical image data from the transmitting apparatus and detects the suspicious region candidate on the basis of a monitoring result of the communication load and the set detection time.

Moreover, preferably, the detecting apparatus receives the medical image data in a time zone in which the communication load is small on the basis of the monitoring result of the communication load.

According to the fourth aspect of the present invention, the communication load of the communication network is monitored, and the detection time of the suspicious region candidate is set. Then, the suspicious region candidate detecting apparatus receives the medical image data in the time zone in which the communication load is small on the basis of the monitoring result and the detection time. Consequently, the communication load of the communication network can be reduced. Moreover, because the detection time is set, the load to be imposed on suspicious region candidate detection can be dispersed. Consequently, improvement of image processing efficiency in the medical image processing system can be achieved.

Further, preferably, the medical image processing system comprises a priority setting section for setting priority of receiving the medical image data,

wherein the detecting apparatus receives the medical image data according to the set priority.

According to the invention, the priority of receiving medical image data is set. Consequently, the detection result of the suspicious region candidate of the medical image data can be obtained according to the priority, and thereby, improvement of diagnosis efficiency of a radiograph interpreting doctor can be achieved.

Moreover, preferably, the detection time set by the time setting section is a time for starting the detection of the suspicious region candidate.

According to the invention, the detection start time of the suspicious region candidate is set as the detection time. Consequently, the detection start time can be specified according to the operation situation of a radiograph interpreting doctor. Hence, the load to be imposed on suspicious region candidate detection can be dispersed, and thereby, improvement of diagnosis efficiency can be achieved.

Further, preferably, the detection time set by the time setting section is a time for ending the detection of the suspicious region candidate.

According to the invention, the detection end time of the suspicious region candidate is set as the detection time. Consequently, the detection end time can be specified according to the operation situation of a radiograph interpreting doctor. Hence, the load to be imposed on suspicious region candidate detection can be dispersed, and thereby, improvement of diagnosis efficiency can be achieved.

Moreover, preferably, the detecting apparatus receives all the medical image data belonging to the same examination.

According to the invention, all the medical image data of the same examination is received. Consequently, the detection result of the suspicious region candidate can be obtained per examination, and thereby, improvement of diagnosis efficiency of a radiograph interpreting doctor can be achieved. Moreover, the suspicious region candidate detection processing performing the comparison of the detection result of the suspicious region candidate per examination is enabled, and thereby, improvement of detection accuracy can be expected.

Further, the medical image processing system preferably comprises a reception history storage section for storing information of a reception history when the medical image data is received from the transmitting apparatus.

According to the invention, the reception history of the medical image data is stored. Consequently, confirmation of reception situation of the medical image data becomes easy.

Moreover, preferably, the detecting apparatus is an integrated apparatus with a medical image generating apparatus for generating the medical image data of the radiographed subject.

According to the invention, the medical image generating apparatus and the suspicious region candidate detecting apparatus may be an integrated apparatus.

Further, preferably, an output apparatus for outputting the medical image data about which the detection of the suspicious region candidate has ended and a detection result of the suspicious region candidate is connected to the communication network.

Moreover, preferably, the output of the medical image data by the output apparatus is any one of output for a film, output for a storage medium and display output.

According to the invention, the medical image data about which the detection of the suspicious region candidate has ended and the detection result of the suspicious region candidates are outputted to a film or a recording medium or are display-outputted by the output apparatus. Consequently, the detection result of the suspicious region candidate can be easily confirmed.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a view showing a system configuration of a medical image processing system of a first embodiment to which the present invention is applied;

FIG. 2 is a view showing a functional configuration of a medical image generating apparatus shown in FIG. 1;

FIG. 3 is a view showing a functional configuration of a suspicious region candidate detecting apparatus shown in FIG. 1;

FIG. 4 is a flowchart showing image transmission processing to be executed by the medical image generating apparatus shown in FIG. 2;

FIG. 5 is a flowchart showing priority setting processing to be executed by the medical image generating apparatus shown in FIG. 2;

FIG. 6 is a view showing a screen example of a setting screen to be displayed on a display section in the priority setting processing;

FIG. 7 is a view showing a functional configuration example of the medical image generating apparatus when a network monitoring apparatus is installed in the medical image processing system shown in FIG. 1;

FIG. 8 is a view showing a functional configuration example of the medical image generating apparatus when the medical image generating apparatus in FIG. 2 and the suspicious region candidate detecting apparatus in FIG. 3 are integrated into one body;

FIG. 9 is a view showing a system configuration of a medical image processing system of a second embodiment to which the present invention is applied;

FIG. 10 is a view showing a functional configuration of a medical image generating apparatus shown in FIG. 9;

FIG. 11 is a view showing a functional configuration of a suspicious region candidate detecting apparatus shown in FIG. 9;

FIG. 12 is a flowchart illustrating image reception processing to be executed by the suspicious region candidate detecting apparatus shown in FIG. 10;

FIG. 13 is a flowchart illustrating detection time setting processing to be executed by the suspicious region candidate detecting apparatus shown in FIG. 11;

FIG. 14 is a view showing a screen example of a setting screen to be displayed on the display section in the detection time setting processing; and

FIG. 15 is a view showing a functional configuration example of the suspicious region candidate detecting apparatus when a network monitoring apparatus is installed in the medical image processing system shown in FIG. 9.

### PREFERRED EMBODIMENT OF THE INVENTION

In the following, embodiments of the present invention will be described in detail with reference to drawings.

<First Embodiment>

With respect to a first embodiment, descriptions will be given to an example in which a medical image generating apparatus will monitor the communication load of a communication network N and medical image data being an object of detection of suspicious region candidates will be transmitted to a suspicious region candidate detecting apparatus in a time zone such that the communication load will be small on the basis of the monitoring results.

First, the configuration of the first embodiment will be described.

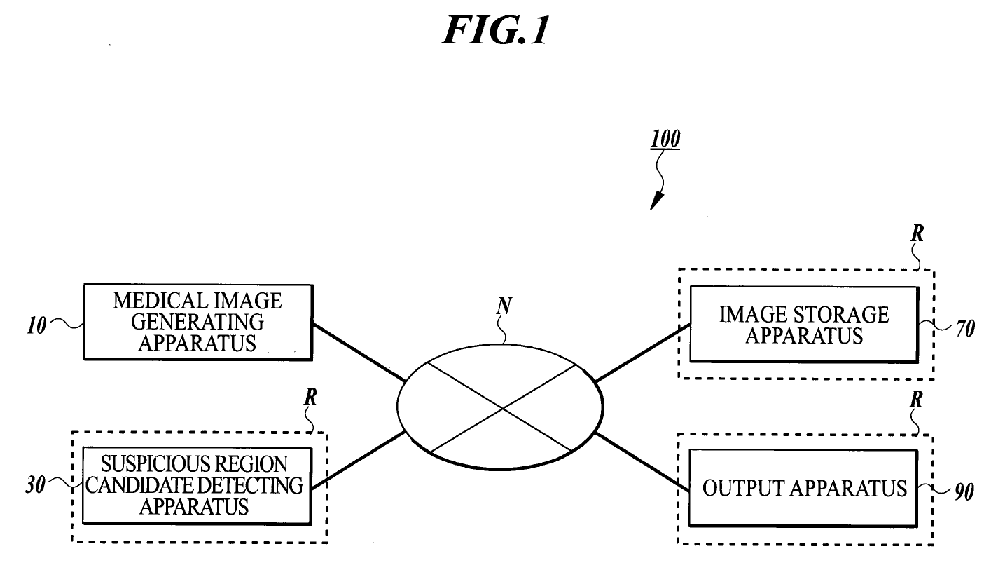

FIG. 1 shows the system configuration of a medical image processing system 100 of the first embodiment.

As shown in FIG. 1, the medical image processing system 100 comprises a medical image generating apparatus 10, a suspicious region candidate detecting apparatus 30, an image storage apparatus 70 and an output apparatus 90. Each apparatus is connected to each other so that transmission and reception of information can be performed through a communication network N. The suspicious region candidate detecting apparatus 30, the image storage apparatus 70 and the output apparatus 90 are medical image receiving apparatuses R for receiving medical image data generated by the medical image generating apparatus 10.

Incidentally, in FIG. 1, the example in which each kind of apparatus is severally connected to the communication network N is shown. However, the installation place and the number of each kind of apparatus are not limited. Moreover, other apparatuses such as a terminal apparatus and the like for being installed in each medical care department for processing medical images may be connected to the communication network N.

The communication network N is a local area network (LAN) as which various communication lines such as telephone lines, dedicated lines, movable body communication networks, communication satellite networks, cable television service (CATV) lines and the like can be applied. Incidentally, various network modes such as a wide area network (WAN), Internet and the like may be applied. However, because the medical images to be transmitted and received between each apparatus through the communication network N is personal information of patients, it is preferable that the communication network N is a dedicated network in which security is secured from the point of view of the reliability of information management.

In the following, each apparatus will be described.

The medical image generating apparatus 10 generates a medical image of a radiographed patient as digital image data. In the present embodiment, descriptions will be given to an example in which a CR (Computed Radiography) apparatus for reading a radiographic image of a radiographed patient to convert the read radiographic image to digital image data is applied as the medical image generating apparatus 10.

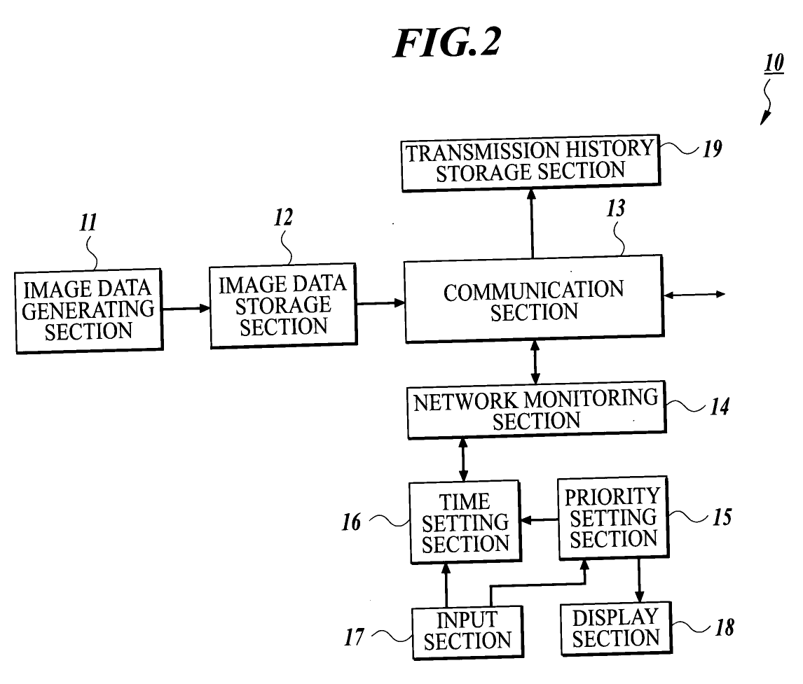

FIG. 2 shows the functional configuration of the medical image generating apparatus 10.

As shown in FIG. 2, the medical image generating apparatus 10 comprises an image data generating section 11, an image data storage section 12, a communication section 13, a network monitoring section 14, a priority setting section 15, a time setting section 16, an input section 17, a display section 18 and a transmission history storage section 19.

The image data generating section 11 comprises a radiographing panel on which a photostimulable phosphor layer is formed, an excitation light generator, a photoelectric conversion element such as a charge coupled device (CCD) or the like, an analog to digital (A/D) converter and the like. The image data generating section 11 absorbs the radiation which has penetrated a subject with the radiographing panel, and irradiates the radiographing panel with excitation light to scan the radiographing panel. Then, the image data generating section 11 generates an analog image signal by photoelectrically converting the fluorescence radiated from the radiographing panel, and further performs A/D conversion of the analog image signal to generate digital image data. The generated image data is output to the image data storage section 12.

Incidentally, a flat panel detector (hereinafter referred to as a “FPD”) can be applied as the image data generating section 11. As described in, for example, Japanese Patent Laid-Open Publication No. Hei 6-342098, an FPD comprises radiation detecting elements for generating electric charges in proportion to the intensity of irradiated radiation and capacitors for storing the electric charges generated by the radiation detecting elements, all of which are two-dimensionally arranged. The FPD picks up a radiographic image of a subject to output the radiographic image as an electric signal.

Moreover, the image data generating section 11 forms a header area for recording the information pertaining to a medical image in generated medical image data, and records in the header area patient information such as the name of a radiographed patient, a patient identification (ID) (the ID for identifying a patient individually), the name of the doctor in charge, and the like, and radiographing information such as radiographing conditions (radiographing regions and radiographing directions) at the time of radiographing, a radiographing date and the like.

Moreover, the image data generating section 11 records in the above-described header area the information pertaining to an examination to which the medical image belongs. The information includes, for example, an examination ID (the ID for identifying an examination individually), the request department of the examination, and the like. Because there is the case where radiography is performed plural times to the same patient from different radiographing directions and with different radiographing apparatus at an examination, the same examination ID is given to the medical image data belonging to the same examination, and one piece or plural pieces of medical image data to which the same examination ID is given is transmitted in a lump as a series of data group when the medical image data is transmitted.

The image data storage section 12 comprises a magnetic recording medium, an optical recording medium, a semiconductor memory or the like, and stores image data generated by the image data generating section 11.

The communication section 13 is an interface connectable to the communication network N, and comprises a network interface card, a modem, a terminal adapter or the like. The communication section 13 transmits the medical image data stored in the image data storage section 12 to a transmission destination such as the suspicious region candidate detecting apparatus 30, the image storage apparatus 70 or the like.

The network monitoring section 14 always detects the communication speed of the communication network N and monitors the communication load of the communication network N by transmitting and receiving, for example, test data whose data amount is previously grasped through the communication section 13. Moreover, the network monitoring section 14 may predict the communication load every hour by accumulating the history of detected communication speeds and by collecting the statistics of the communication load during a predetermined period.

The priority setting section 15 sets the priority of transmitting medical image data to the suspicious region candidate detecting apparatus 30 according to the item of the priority selected by a user. The set priority is recorded in the header area of the medical image data.

The time setting section 16 sets an image transmission time for transmitting medical image data to the suspicious region candidate detecting apparatus 30 on the basis of the priority of transmitting the monitoring results of the communication network N and the medical image data.

The input section 17 comprises a keyboard including cursor keys for performing the setting operations of priority and various function keys, and the like, and the input section 17 outputs input signals according to the operations of the user to the priority setting section 15. Incidentally, a pointing device such as a mouse or the like may be applied, or the input section 17 may be formed as a touch panel in which the input section 17 is integrated with the display section 18 into one body.

The display section 18 comprises a display such as a liquid crystal display (LCD) or the like, and displays a setting screen 181 for setting priority.

The transmission history storage section 19 comprises a magnetic recording medium, an optical recording medium, a semiconductor memory or the like, and stores the information of transmission history of the medical image data transmitted through the communication section 13. As the information of the transmission history, the information such as the image file names, the transmission dates of transmitted medical image data, and the like, is stored.

Incidentally, the medical image generating apparatus 10 is not limited to the above-described CR apparatus, and digital image data may be generated by applying a laser digitizer for scanning a film recording a medical image with a laser beam to measure the quantity of light which has penetrated the film and to perform digital conversion of the value of the measured quantity of light. Moreover, a computer-aided fault image radiographing apparatus (hereinafter referred to “computed tomography (CT)), MRI, an ultrasonic image reading apparatus or the like may be applied to generate medical image data.

Next, the suspicious region candidate detecting apparatus 30 will be described.

The suspicious region candidate detecting apparatus 30 is an image processing apparatus for performing the image analysis of medical image data to detect and output the image area which looks like a suspicious region as a suspicious region candidate.

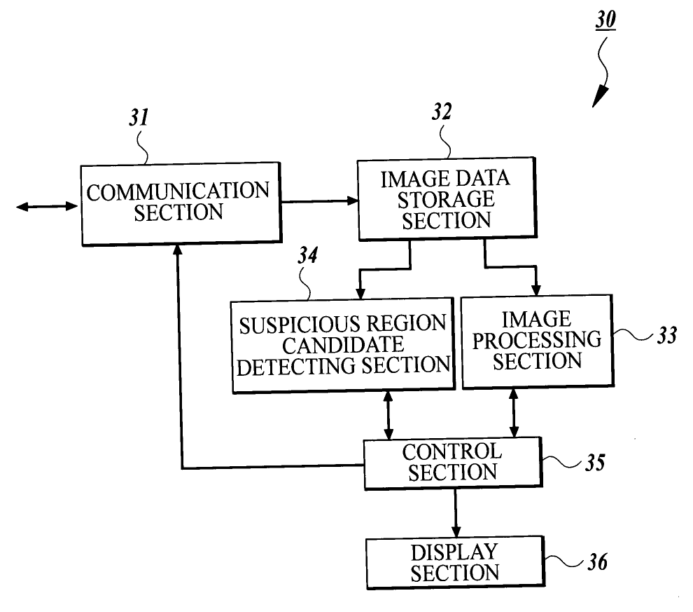

FIG. 3 shows the functional configuration of the suspicious region candidate detecting apparatus 30.

As shown in FIG. 3, the suspicious region candidate detecting apparatus 30 comprises a communication section 31, an image data storage section 32, an image processing section 33, a suspicious region candidate detecting section 34, a control section 35 and a display section 36.

The communication section 31 is an interface connectable to the communication network N, and comprises a network interface card, a modem, a terminal adapter or the like. The communication section 31 receives medical image data from, for example, the medical image generating apparatus 10, and transmits the medical image data about which the processing of suspicious region candidate detection has ended and the detection result to the output apparatus 90.

The image data storage section 32 comprises a magnetic recording medium, an optical recording medium, a semiconductor memory or the like, and stores the image data received by the communication section 31.

The image processing section 33 performs various kinds of image processing of the medical image data inputted from the image data storage section 32, and outputs the processed image data to the control section 35. The various kinds of image processing includes gradation processing for adjusting an image contrast, contrast correction processing for suspicious region candidate detection, frequency enhancement processing for adjusting the sharpness of an image, dynamic range compression processing for compressing the dynamic range of an image having a wide dynamic range within a density range in which the image can be easily observed without deteriorating the contrasts of the details of a subject, and the like.

The suspicious region candidate detecting section 34 reads the image data from the image data storage section 32 to perform image analysis of the read image data, and thereby detects image areas which look like suspicious regions. In the present embodiment, the example in which suspicious region candidates is detected from mammography will be described. However, the detection objects are not limited to the mammography images, and other regions such as a pectoral region, an abdominal region or the like may be radiographed, and suspicious region candidates according to each of the regions may be detected on the basis of the radiographed images.

In mammography, suspicious regions which look like tumors or clustered micro-calcification, which are features of a breast cancer, are detected. The suspicious region of a tumor is a lump having a certain degree of size. The suspicious region appears as a whitish round suspicious region having an almost Gaussian distribution in the mammography. With regard to the minute calcified cluster, the existence of a gathering of minute calcified portions (as a cluster) indicates high possibility that the gathering is an early cancer. In the mammography, the early cancer appears as a whitish round suspicious region having an almost circular conic structure.

In the following, a technique for detecting the suspicious regions of tumors and the suspicious regions of clustered micro-calcification will be described.

It is possible to apply the well-known detection methods disclosed in the following articles to the suspicious region candidate detecting section 34 as the techniques suitable for the detection of the suspicious regions of tumors.

A method for detecting by comparing the right side and the left side breasts (Med. Phys., Vol. 21. No. 3, pp. 445-452).

A method for detecting by using an iris filter (IEICE Trans. (Japanese Edition) (D-11), Vol. J75-D-11, no. 3, pp. 663-670, 1992).

A method for detecting by using a Quoit filter (IEICE Trans. (Japanese Edition) (D-11), Vol. J76-D-11, no. 3, pp. 279-287, 1993)

A method for detecting by binarization based on a histogram of pixel values in divided breast areas (JAMIT Frontier Collected Papers of Lectures, pp. 84-85, 1995).

A minimum direction differential filer for taking the minimum output of many Laplacian filters having directional properties (IEICE Trans. (Japanese Edition) (D-11), Vol. J76-D-11, no. 2, pp. 241-249, 1993).

A method for sifting benign tumors and malign tumors of the suspicious regions of tumors by using fractal dimensions (Medical Imaging Technology 17(5), pp. 577-584, 1999)

Moreover, the well-known detection methods disclosed in the following papers can be applied as the methods suitable for detecting minute calcified cluster suspicious regions.

A method for localizing areas which are suspicious to be calcified from a breast area and deleting false positive candidates on the basis of the standard deviation values or the like of the optical density differences and the boundary density differences of suspicious region images (IEEE Trans Biomed Eng BME-26(4): pp. 213-219, 1979).

A method for detecting by using images to which Laplacian filter processing is performed (IEICE Trans. (Japanese Edition) (D-11), Vol. J71-D-11, no. 10, pp. 1994-2001, 1988).

A method for detecting by using images which are analyzed by morphology analysis for suppressing the influences of the background pattern of mammary glands or the like (IEICE Trans. (Japanese Edition) (D-11), Vol. J71-D-11, no. 7, pp. 1170-1176, 1992).

The suspicious region candidate detecting section 34 performs detection of suspicious region candidates by using the above-mentioned techniques. Various characteristic amounts are used for the detection of the suspicious region candidates. The various characteristic amounts are, for example, the position information of suspicious regions in medical image data, the sizes (areas) of the suspicious regions, contrasts being the differences of the density values between the inner side and the outer side of the suspicious regions, the intensity components and direction components of the concentration gradients from the peripheral parts to the central parts of the suspicious regions, and the like. The various characteristic amounts of the suspicious regions detected as the suspicious region candidates are outputted to the control section 35 as detection results.

The control section 35 comprises a central processing unit (CPU) and the like, and performs the output control of the medical image data to be outputted to the communication section 31 or the display section 36. The control section 35 outputs to the communication section 31 the information of a detection result by a suspicious region candidate detecting section 34 together with the medical image data the image processing of which has been performed by the image processing section 33. Moreover, the control section 35 outputs the image areas of suspicious region candidates in an identifiable state by marking the image areas of the suspicious region candidates with arrows by changing the colors of the image areas from the colors of the other areas, or the like, on the basis of the detection results from the suspicious region candidate detecting section 34 at the time of outputting the medical image data to which the image processing has been performed to the display section 36.

As the display section 36, a cathode ray tube (CRT), an LCD, a plasma display or the like can be applied. Among them, a CRT or a liquid crystal display which is dedicated for medical images and has fine high brightness is preferable. Moreover, a highly fine display having the number of pixels to be displayed of about 1000×1000 or more is preferable. A highly fine display having the number of pixels to be displayed of about 2000×2000 or more is especially preferable.

Next, the image storage apparatus 70 will be described.

The image storage apparatus 70 comprises a communication section and a large capacity storage section such as a hard disk or the like. The image storage apparatus 70 forms the medical image data transmitted from the medical image generating apparatus 10, the suspicious region candidate detecting apparatus 30 and the like on the communication network N into a data base, and stores the data base therein. When the image storage apparatus 70 receives a request of medical image data from each apparatus on the communication network N, the image storage apparatus 70 distributes the specified medical image data to a specified transmission destination.

Next, the output apparatus 90 will be described.

The output apparatus 90 comprises a communication section, and outputs the medical image data received through the communication network N.

As the output apparatus 90, a display output apparatus which is dedicated for medical images and has fine high brightness, such as a CRT, a liquid crystal display, a plasma display or the like can be applied.

Moreover, as the output apparatus 90, a film output apparatus can be applied. In this case, the output apparatus 90 performs exposure processing of a film on the basis of the medical image data received through the communication network N, and records a medical image on the film.

Moreover, as the output apparatus 90, a printer for forming an image on a recording medium such as paper or the like on the basis of image data, or the like can be applied. In this case, the output apparatus 90 forms an image on the recording medium on the basis of the medical image data received through the communication network N, and outputs the recording medium.

Next, the operation of the first embodiment will be described.

In the first embodiment, descriptions will be given to an example in which the medical image generating apparatus 10 sets a time for transmitting the medical image data generated on the basis of a network monitoring result to the suspicious region candidate detecting apparatus 30 in a time zone such that the communication load of the network N is small.

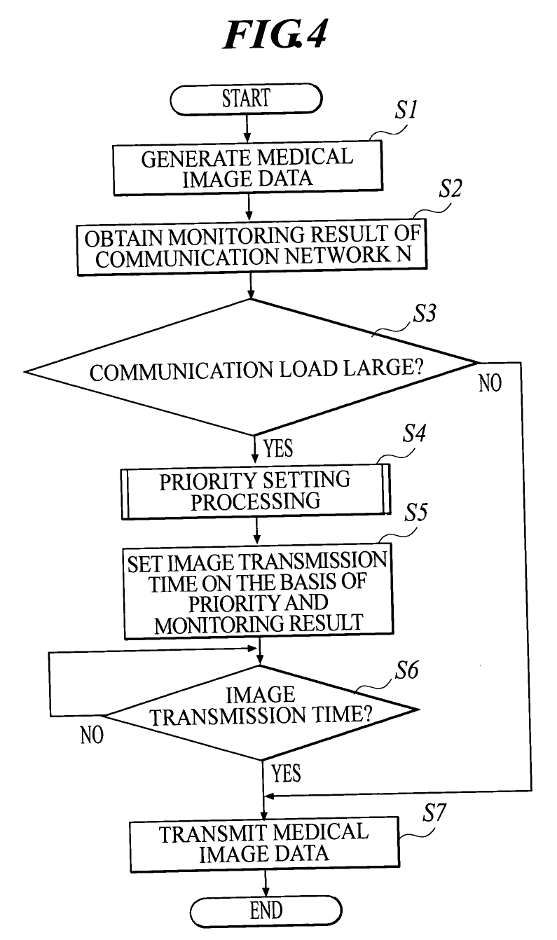

FIG. 4 is a flowchart illustrating image transmission processing to be executed by the medical image generating apparatus 10.

In the image transmission processing shown in FIG. 4, first, at Step S1, medical image data based on the radiography of a patient is generated by the image data generating section 11. At this time, in the header area of the generated medical image data, various kinds of information pertaining to the medical image, such as patient information, radiographing information, examination information and the like, are recorded. The medical image data about which the recording of the information has ended is stored in the image data storage section 12.

Next, at Step S2, when the network monitoring section 14 obtains a monitoring result of the communication network N, at Step S3, whether the present communication load is large or not is judged by the time setting section 16 on the basis of the obtained monitoring result. When the communication load is judged to be small (No at Step S3), it is judged that the present time zone is one having a small communication load. Then, the image transmission processing proceeds to the processing at Step S7, and the communication section 13 transmits the medical image data stored in the image data storage section 12 to the suspicious region candidate detecting apparatus 30. Further, at that time, the transmission history information when the medical image data is transmitted by the communication section 13 is stored in the transmission storage section 19. On the other hand, when the communication load is judged to be large, the image transmission processing proceeds to the priority setting processing at Step S4.

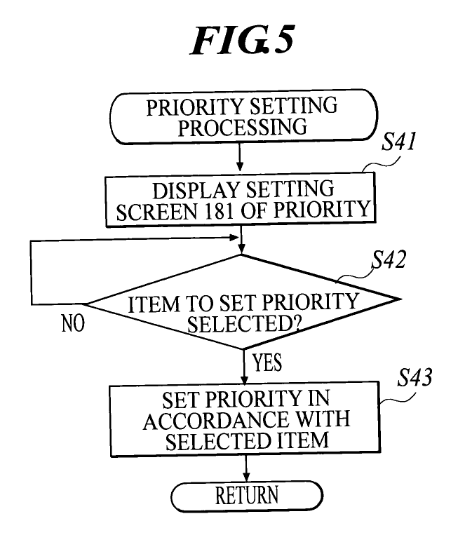

The priority setting processing at Step S4 is described with reference to FIG. 5. The priority setting processing is the processing for setting the priority of transmitting medical image data.

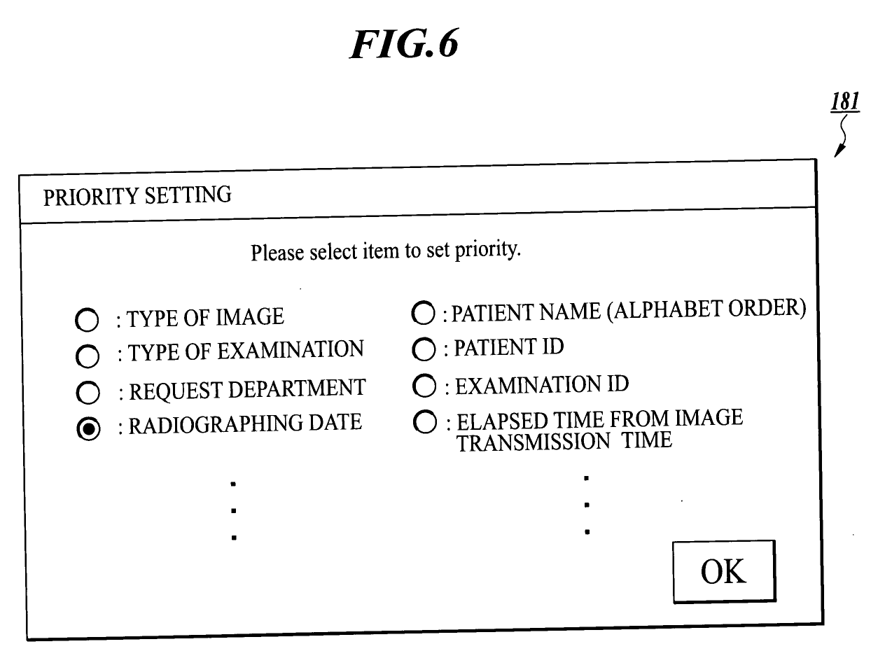

In the priority setting processing shown in FIG. 5, first, at Step S41, the setting screen 181 (see FIG. 6) for setting the priority of transmitting medical image data is displayed on the display section 18.

As shown in FIG. 6, the setting screen 181 displays items to which priority is set in a state capable of being selected. The items are the type of an image, the type of an examination, a request department, a radiographing date, a patient name, a patient ID, an examination ID, an elapsed time from an image transmission time, and the like. A user operates the input section 17 to input the selection of a desired item. Incidentally, the selection may be performed only to one item, or may be performed to a combination of a plurality of items.

At Step S42, it is judged whether the selection of an item or items about which priority is set has been inputted in the setting screen 181 through the input section 17 and the end of the input has been instructed or not. When no selection of the item about which priority is set is inputted (No at Step S42), the priority setting process waits for an input. When the selection of an item has been inputted and the end of the input has been instructed (Yes at Step S42), the priority setting process proceeds to Step S43.

At Step S43, the priority setting section 15 sets priority in accordance with the item or the items the selection of which has been inputted. For example, when the item of the type of an examination has been selected, priority is set for every type of an examination such as the examination of a stomach, the examination of a liver and the like. When the item of the radiographing date has been selected, priority is set in the order of the earliness of radiographing dates. Incidentally, when a plurality of items, for example, the type of an examination and the radiographing data, and the like, is selected, the selected items are combined for setting priority. In the exemplified case, the priority is set in the order of the earliness of radiographing dates in each type of an examination.

Incidentally, the priority setting processing may be executed every reception of medical image data to set the items about which the priority is set every execution of the priority setting processing. Otherwise, when the setting of priority is not performed frequently, the items about which priority is set may be once set in the setting screen 181, and after that the set items about which the priority is set may be fixed. When the items about which the priority is set are fixed, the setting of the items is made to be able to be changed as the need arises. Moreover, a confirmation screen for confirming the fixed items about which priority is set may be displayed on the display section 18 every reception of medical image data.

The information of the priority set as above is recorded in the header area of medical image data. When the record has ended, the processing proceeds to Step S5 shown in FIG. 4.

At Step S5, an image transmission time for transmitting medical image data to the suspicious region candidate detecting apparatus 30 is set by the time setting section 16 on the basis of the monitoring result of the communication network N and the priority set by the priority setting processing.

For example, the image transmission time may be set so as to transmit medical image data within a predetermined time, for example, within 30 minutes or the like, after a point of time when the communication load is judged to be small during the monitoring of the communication network N. Otherwise, the information of a time zone in which the communication load is small may be obtained on the basis of the statistics of the communication loads of the communication network N, and then the image transmission time may be suitably set in the obtained time zone. Moreover, the image transmission time may be set in consideration of how many medical images in which suspicious region candidates are to be detected exist in addition to the communication load.

When the image transmission time is set by the time setting section 16, the transmission of medical image data is waited until the image transmission time. Then, at Step S6, it is judged whether the image transmission time has elapsed or not. When the image transmission time has elapsed (Yes at Step S6), the image transmission processing proceeds to Step S7. At Step S7, medical image data is read from the image data storage section 12, and the medical image data is transmitted to the suspicious region candidate detecting apparatus 30 by the communication section 13 in descending order of the priority on the basis of the priority and the examination information, both recorded in the header area of the medical image data. At this time, the medical image data for the same examination is transmitted in a lump.

In the suspicious region candidate detecting apparatus 30, the detection of suspicious region candidates in the medical image data is started in the order of the earliness of reception of the medical image data by using the reception of the medical image data from the medical image generating apparatus 10 as a trigger. When the detection of the suspicious region candidates has ended, the medical image data about which the detection has ended is transmitted to the output apparatus 90 in order together with the detection result of the suspicious region candidates. The output apparatus 90 outputs the medical image data and the detection result of the suspicious region candidates of the medical image data. In the output apparatus 90, output of the medical image data and the detection result have been received from the suspicious region candidate detecting apparatus 30 is performed.

As described above, the communication load of the communication network N is monitored, and the image transmission time of the medical image data to be transmitted from the medical image generating apparatus 10 to the suspicious region candidate detecting apparatus 30 is set on the basis of the monitoring result. Consequently, the image transmission time can be set in a time zone in which the communication load is small. Hence, the maximum communication load of the communication network N can be reduced, and processing relating to suspicious region candidate detection can be performed by using the existing network and maintaining the whole responsiveness.

Moreover, the priority of transmitting medical image data is set, and the suspicious region candidate detecting apparatus 30 starts to detect suspicious region candidates in the order of the earliness of reception of the medical image data by utilizing the reception of medical image data as a trigger. Consequently, the detection results of the suspicious region candidates can be obtained in descending order of the priority of the medical image data, and thereby the improvement of the diagnosis efficiency of a radiograph interpreting doctor can be achieved.

Moreover, when medical image data is transmitted, the medical image data for the same examination is transmitted in a lump. Consequently, the detection results of suspicious region candidates can be obtained per examination, and the improvement of the diagnosis efficiency of a radiograph interpreting doctor can be achieved. Moreover, the suspicious region candidate detection processing performing the comparison of the detection results of suspicious region candidates per examination is enabled, and thereby the improvement of detection accuracy can be expected.

Incidentally, the contents described with regard to the first embodiment are related to a preferable example of the medical image processing system 100 to which the present invention is applied, and the present invention is not limited to the contents.

For example, the network monitoring section 14, the time setting section 16 and the priority setting section 15 may be installed in another apparatus such as the suspicious region candidate detecting apparatus 30, image storage apparatus 70 or the like. Thereby, the medical image generating apparatus 10 may obtain from the apparatus which has installed the sections 14-16 therein the monitoring result of the communication network N by the network monitoring section 14, the information of the priority set by the priority setting section 15, and the information of the image transmission time set by the time setting section 16. Then, the medical image generating apparatus 10 may transmit medical image data.

Moreover, the medical image generating apparatus 10 comprises the transmission history storage section 19. However, the present invention is not limited to this. The transmission history storage section may be provided in another apparatus on the communication network N, to manage the transmission history.

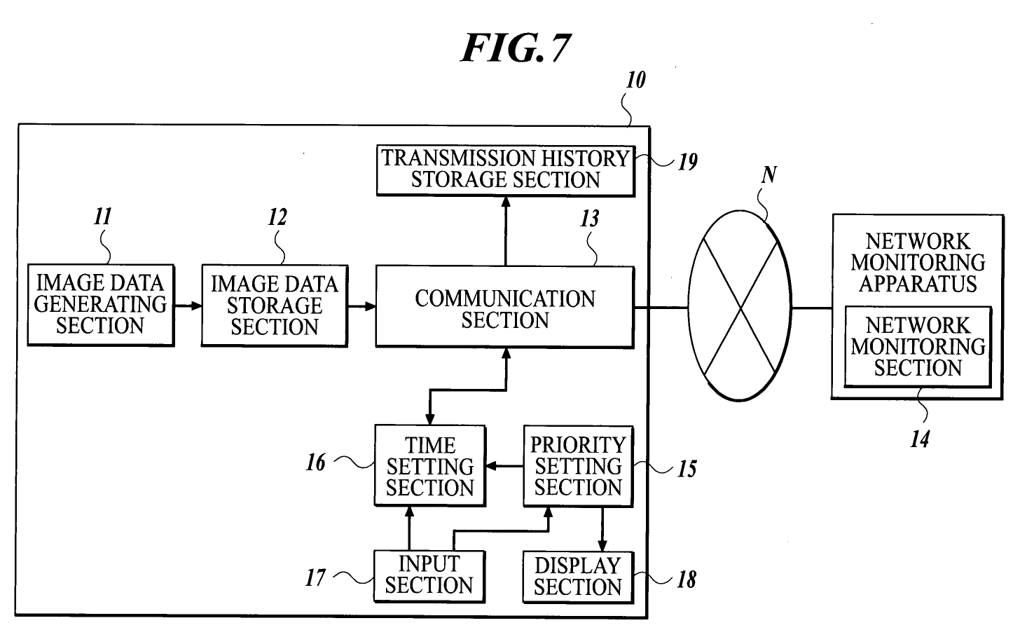

Moreover, the medical image generating apparatus 10 comprises the network monitoring section 14 therein. However, as shown in FIG. 7, the network monitoring section 14 may be installed in an information processing apparatus such as a personal computer equipped with a communication section, a mobile telephone, a personal digital assistant (PDA) or the like, and the information processing apparatus may be incorporated into a medical image processing system as the network monitoring apparatus.

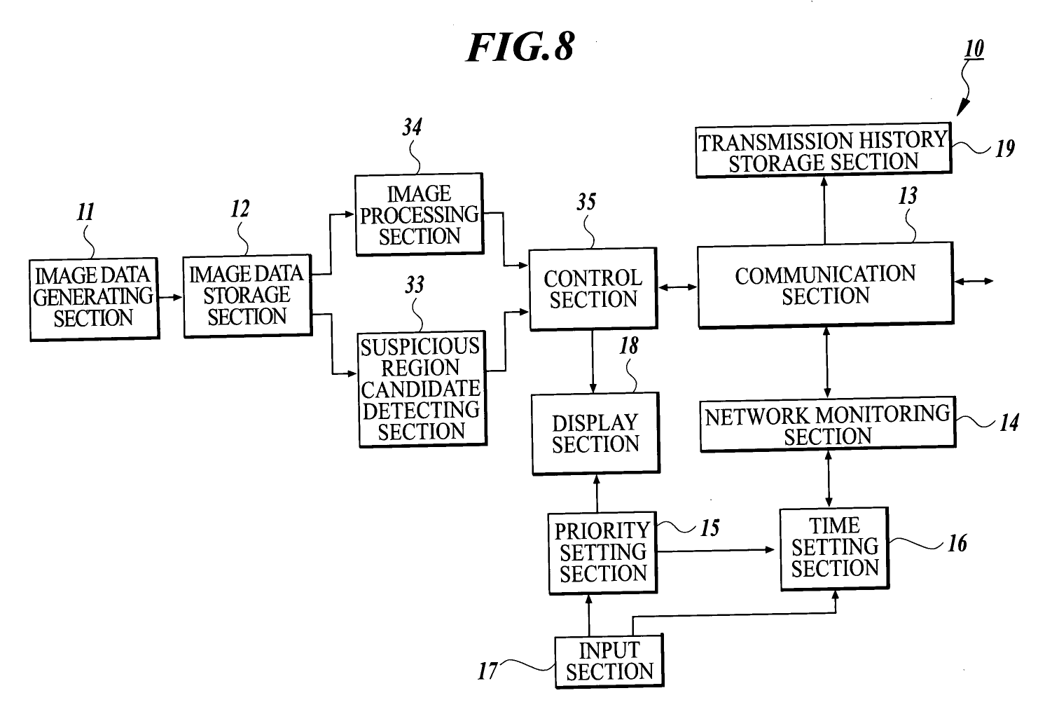

Moreover, in the above descriptions, the medical image generating apparatus 10 and the suspicious region candidate detecting apparatus 30 are described as separate apparatus. However, the medical image generating apparatus 10 may be configured as shown in FIG. 8 to be an integrated apparatus including the image data generating function of the medical image generating apparatus 10, and the suspicious region candidate detecting function of the suspicious region candidate detecting apparatus 30.

In this case, immediately after the generation of medical image data by the image data generating section 11, the suspicious region candidate detecting section 34 starts the detection of suspicious region candidates, and the time setting section 16 sets an image transmission time when the medical image data about which the detection of the suspicious region candidates has ended is transmitted to medical image receiving apparatuses such as the image storage apparatus 70, the output apparatus 90 and the like on the communication network N. Moreover, the priority setting section 15 sets priority, and the medical image data about which the detection of the suspicious region candidates has ended is transmitted to the medical image receiving apparatuses through the communication section 13 in descending order of the set priority.

In addition, the detailed configuration and the detailed operation of the medical image processing system 100 of the first embodiment also can be suitably changed without departing from the sprit of the present invention.

<Second Embodiment>

With respect to a second embodiment, descriptions will be given to an example in which a suspicious region candidate detecting apparatus will monitor the communication load of a communication network to set a detection time of suspicious region candidates and then medical image data will be received from a medical image transmitting apparatus in a time zone in which the communication load will be small on the basis of the monitoring results of the communication load and the detection time.

First, the configuration of the second embodiment will be described.

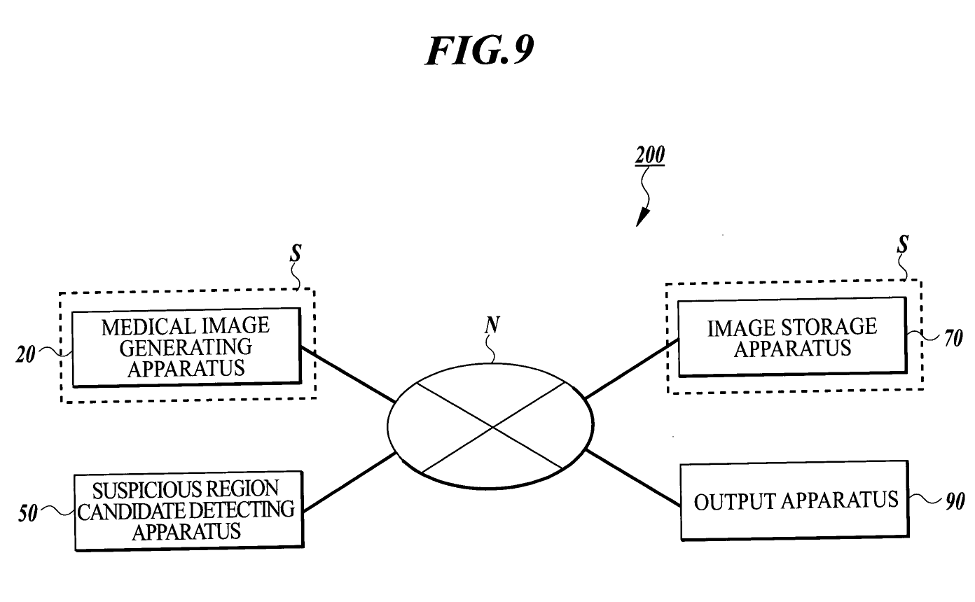

FIG. 9 shows the system configuration of a medical image processing system 200 of the second embodiment. Incidentally, the same constituent apparatus of the medical image processing system 200 as those of the medical image processing system 100 of the first embodiment, that is, the image storage apparatus 70 and the output apparatus 90, are designated by the same reference numerals as those of the medical image processing system 100, and the detailed descriptions of the same constituent apparatus are omitted.

As shown in FIG. 9, the medical image processing system 200 comprises a medical image generating apparatus 20, a suspicious region candidate detecting apparatus 50, an image storage apparatus 70 and an output apparatus 90. Each apparatus is connected to each other so that the transmission and the reception of information can be performed through a communication network N. The medical image generating apparatus 20 and the image storage apparatus 70 are medical image transmitting apparatuses S for transmitting medical image data of a suspicious region candidate detection object to the suspicious region candidate detecting apparatus 50.

Incidentally, in FIG. 9, an example in which each one of the apparatuses is severally connected to the communication network N is illustrated. However, the installation place and the number of every apparatus are not limited. Moreover, other apparatuses such as a terminal apparatus and the like installed in each medical care department for processing medical images may be connected to the communication network N. Moreover, in the present embodiment, the medical image generating apparatus 20 and the image storage apparatus 70 are exemplified as the medical image transmitting apparatus. However, the medical image transmitting apparatus is not limited to the above-mentioned apparatuses 20 and 70, and other apparatuses such as a terminal apparatus and the like in each medical care department may be used as the medical image transmitting apparatus as long as the apparatus can transmit the medical image data of suspicious region candidate detection objects to the suspicious region candidate detecting apparatus.

In the following, each apparatus will be described.

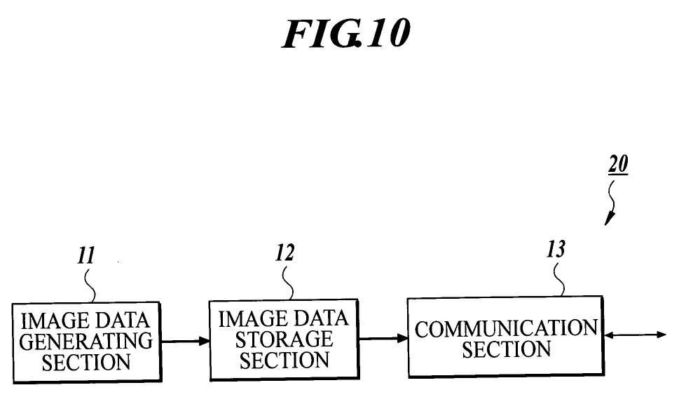

The medical image generating apparatus 20 generates a radiographed medical image as digital image data, and transmits the generated medical image data to the suspicious region candidate detecting apparatus 50. FIG. 10 shows the functional configuration of the medical image generating apparatus 20. In FIG. 10, the sections realizing the same functions as those realized by each section of the medical image generating apparatus 10 in the first embodiment are designated by the same reference numerals as those of the sections of the medical image generating apparatus 10.

As shown in FIG. 10, the medical image generating apparatus 20 comprises an image data generating section 11, an image data storage section 12 and a communication section 13. Because the functions realized by each of the sections 11-13 are the same as those realized by each section described with respect to the first embodiment, the detailed descriptions of the functions realized by the sections 11-13 are omitted.

Next, the suspicious region candidate detecting apparatus 50 will be described.

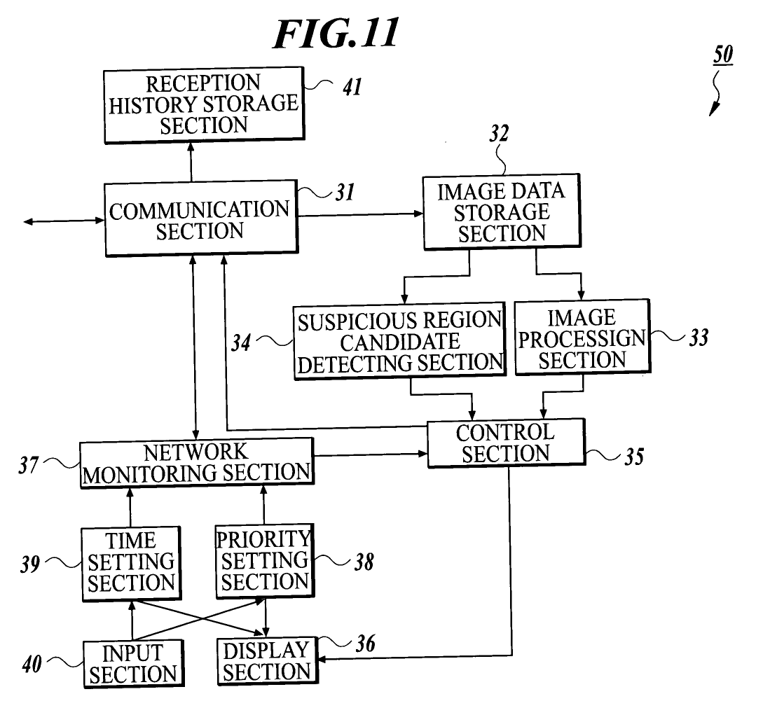

The suspicious region candidate detecting apparatus 50 is an image processing apparatus for performing the image analysis of medical image data to detect the image area which looks like a suspicious region as a suspicious region candidate. FIG. 11 shows the functional configuration of the suspicious region candidate detecting apparatus 50. The sections realizing the same functions as those realized by each section of the suspicious region candidate detecting apparatus 30 in the first embodiment are designated by the same reference numerals as those of the sections of the suspicious region candidate detecting apparatus 30, and the detailed descriptions of the sections are omitted.

As shown in FIG. 11, the suspicious region candidate detecting apparatus 50 comprises a communication section 31, an image data storage section 32, an image processing section 33, a suspicious region candidate detecting section 34, a control section 35, a display section 36, a network monitoring section 37, a priority setting section 38, a time setting section 39, an input section 40 and a reception history storage section 41.

The network monitoring section 37, for example, transmits and receives test data the size of which is previously gasped through the communication section 31 to detect the communication state of the communication network N always for monitoring the communication load of the communication network N. Moreover, the network monitoring section 37 may store the history of the detected communication states to collect the statistics of the communication load during a predetermined period for performing the prediction of the communication load per hour.

The priority setting section 38 sets the priority of receiving medical image data in accordance with the items of priority selected by a user. The set priority is recorded in the header area of the medical image data.

The time setting section 39 sets a detection time at which the detection of suspicious region candidates in medical image data in accordance with an operation input from the input section 40. With regard to the detection time to be set, the user can select a desired one between a detection start time at which detection is started and a detection end time at which detection is ended.

The input section 40 comprises a keyboard or the like for performing setting operations of priority or a detection time. The input section 40 outputs input signals according to the operations of the user to the priority setting section 38 or the time setting section 39. Incidentally, a pointing device such as a mouse or the like may be applied. The input section 40 may be also configured as a touch panel integrated with the display section 36 into one body.

The reception history storage section 41 comprises a magnetic recording medium, an optical recording medium, a semiconductor memory or the like. The reception history storage section 41 stores the information of the reception history of the medical image data received through the communication section 31. As the information of the reception history, the information such as the image file name, the reception date of the received medical image data, and the like is stored.

Next, the operation of the second embodiment will be described.

In the second embodiment, descriptions will be given to an example in which the suspicious region candidate detecting apparatus 50 will monitor the communication load of the communication network N and will set a time for detecting suspicious region candidates and the priority of receiving medical image data to receive the medical image data from the medical image transmitting apparatus in descending order of the priority on the basis of a monitoring result of the communication load and the set detection time in a time zone in which the communication load will be small.

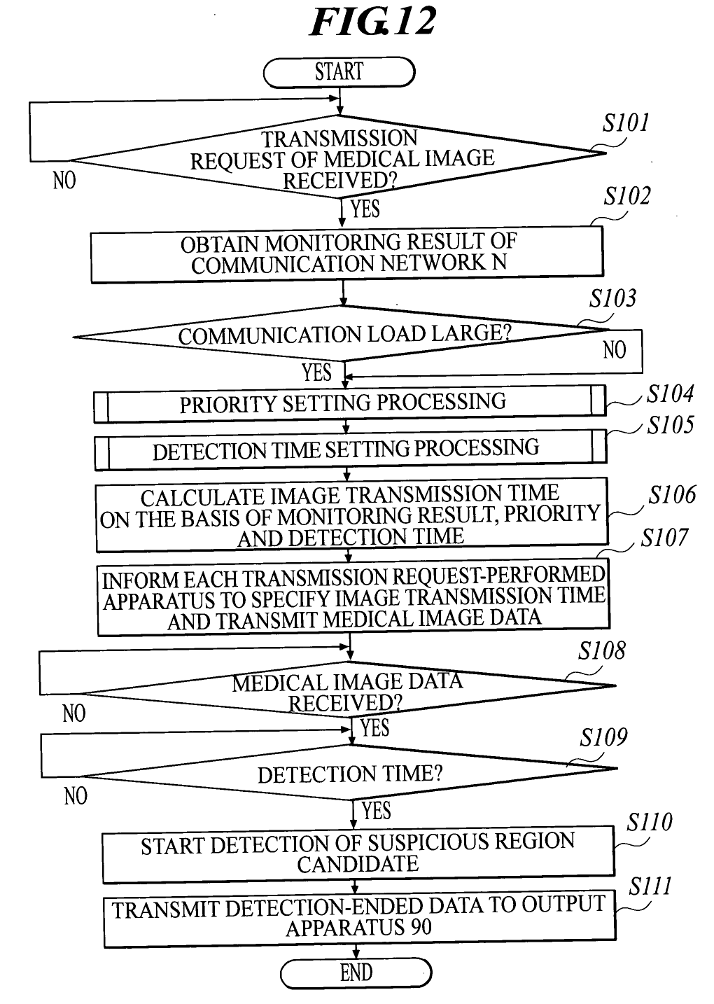

FIG. 12 is a flowchart illustrating image reception processing to be executed by the suspicious region candidate detecting apparatus 50.

In the image reception processing shown in FIG. 12, first, at Step S101, when request information requesting the transmission of the medical image data of a suspicious region candidate detection object is received from a medical image transmitting apparatus such as the medical image generating apparatus 20, the image storage apparatus 70 or the like, the network monitoring section 37 obtains a monitoring result of the communication load of the communication network N at Step S102.

Next, at Step S103, whether the present communication load is large or not is judged on the basis of the obtained monitoring result. When the communication load is judged to be small (No at Step S103), the image reception processing proceeds to Step S107, and the communication section 13 transmits notification information notifying to transmit medical image data within a predetermined time from this moment in time to the medical image transmitting apparatus which has requested a transmission request.

On the other hand, when the communication load is judged to be large (Yes at Step S103), the image reception processing proceeds to the priority setting processing at Step S104. The priority setting processing is the same processing as the priority setting processing in the first embodiment. Accordingly, the priority setting processing is described with reference to FIG. 5.

In the priority setting processing shown in FIG. 5, first, at Step S41, the setting screen 181 (see FIG. 6) for setting the priority of receiving medical image data is displayed on the display section 36. As shown in FIG. 6, the setting screen 181 displays items to which priority is set in a state capable of being selected. The items are the type of an image, the type of an examination, a request department, a radiographing date, a patient name, a patient ID, an examination ID, an elapsed time from an image generation time, and the like. A user inputs the selection of a desired item through the input section 40.

Next, at Step S42, it is judged whether the selection of an item about which priority is set has been inputted in the setting screen 181 and the end of the input has been instructed or not. When no selection of the item about which priority is set is inputted (No at Step S42), the priority setting process waits for an input. When the selection of an item is inputted and the end of the input has been instructed (Yes at Step S42), the priority setting process proceeds to Step S43.

At Step S43, the priority setting section 38 sets priority in accordance with the item the selection of which has been input.

Incidentally, the priority setting processing may be executed every reception of medical image data to set the items about which the priority is set every execution of the priority setting processing. Otherwise, when the setting of priority is not performed frequently, the items about which priority is set may be once set in the setting screen 181, and after that the set items about which the priority is set may be fixed. When the items about which the priority is set are fixed, the setting of the items is made to be able to be changed as the need arises. Moreover, a confirmation screen for confirming the fixed items about which priority is set may be displayed on the display section 36 every reception of medical image data.

When the priority of receiving medical image data has been set, the image reception processing proceeds to the detection time setting processing at Step S105 shown in FIG. 12.

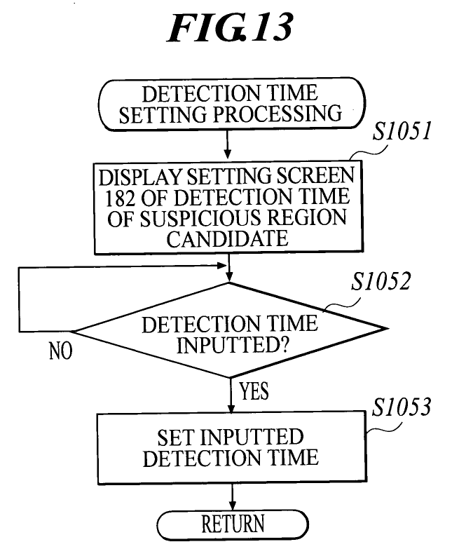

The detection time setting processing is described with reference to FIG. 13.

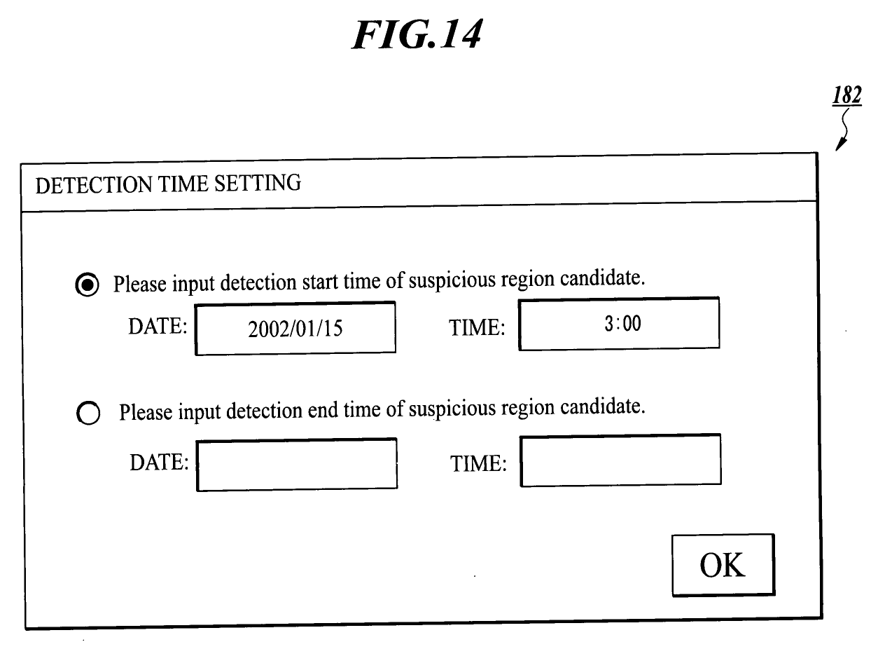

In the detection time setting processing shown in FIG. 13, first, at Step S1051, a setting screen 182 (see FIG. 14) for setting a detection time of suspicious region candidates is displayed on the display section 36. In the setting screen 182, a detection start time for starting the detection of the suspicious region candidates and a detection end time for ending the detection of the suspicious region candidates are displayed as the detection times to be set in a state capable of being selected, and input areas for inputting the setting dates of the detection times are provided.

The user selects one of the detection start time and the detection end time into which the user wants to set a date, and inputs the date to be set into the selected one. For example, in the case where an operation of the suspicious region candidate detecting apparatus 50 such as the interpretation of a radiograph of medical image data in which the detection of suspicious region candidates has ended is performed in the suspicious region candidate detecting apparatus 50, or the like, there is a possibility that the operation of the interpretation of the radiograph becomes slow by the execution of detection processing during the operation. Accordingly, a time of starting the detection of the suspicious region candidates is set so as to coincide with the scheduled ending time of the operation. Moreover, in the case where a desired time to start the interpretation of a radiograph has been determined, a time to end the detection of the suspicious region candidates is set so as to coincide with the time when the interpretation of the radiograph is desired to be started.

Next, at Step S1052, whether a detection time has been inputted through the input section 40 and the end of the input has been instructed or not is judged. When no detection time has been inputted (No at Step S1052), the detection time setting processing waits for the input. When a detection time has been inputted and the end of the input has been instructed (Yes at Step S1052), the detection time setting processing proceeds to Step S1053.

At Step S1053, the time setting section 39 sets the inputted detection time. For example, when the selection of a detection start time has been inputted and the date has been inputted as “2002/01/15, 3:00”, the detection time is set so as to perform the detection of suspicious region candidates at three in the morning of Jan. 15, 2002. Moreover, when the selection of a detection end time has been inputted and a date has been inputted therein, a detection start time is calculated so as to end the detection by the inputted date on the basis of the time necessary for the detection (hereinafter referred to as a “time necessary for detection”) which has been previously grasped.

When the setting of the detection time has ended, the processing proceeds to Step S106 shown in FIG. 12.

At Step S106, an image transmission time for transmitting each medical image data to the suspicious region candidate detecting apparatus 30 is calculated on the basis of the monitoring result of the communication load, the priority set by the priority setting processing and the detection time set at the detection time setting processing.

For example, when there is a time to spare by the set detection time, the communication speed of the communication network N is always detected. At the point of time when the communication load is judged to be small on the basis of the communication speed, the image transmission time may be calculated so as to transmit medical image data within a predetermined time, for example, within 30 minutes or the like, after the point of time. Otherwise, the information of a time zone in which the communication load is small may be obtained on the basis of the statistics of the communication load of the communication network N, and then the image transmission time may be suitably calculated in the time zone.

When the image transmission time has been calculated, the calculated image transmission time is specified to the medical image transmitting apparatus which has performed the transmission request of medical image data, and notification is performed by the communication section 31 to transmit the medical image data at the specified time together with the notification of the priority of the reception of the medical image data at Step S107. After the notification, the suspicious region candidate detecting apparatus 50 waits for the transmission of the medical image data from the medical image transmitting apparatus.

The medical image transmitting apparatus which has received the notification of the image transmission time from the suspicious region candidate detecting apparatus 50 transmits the medical image data being the transmission object to the suspicious region candidate detecting apparatus 50 at the image transmission time in descending order of the priority on the basis of the notified priority information. Incidentally, at the time of transmission, the priority information is recorded in the header area of the medical image data, and the information of the examination ID recoded in the header area is read. Then, the medical image data for the same examination is transmitted in a lump.

Next, at Step S108, whether the medical image data has been received or not from the medical image transmitting apparatus through the communication section 31 is judged. When the medical image data has been received (Yes at Step S108), the received medical image data is stored in the image data storage section 32. Then the detection of the suspicious region candidates in the stored medical image data is waited for until the set detection time has elapsed. Incidentally, when a detection start time has been set as the detection time, the elapse of the detection start time is waited for. When a detection end time has been set, the elapse of the detection stating time calculated in consideration with the time necessary for detection is waited for.

Next, at Step S109, it is judged whether the detection time has elapsed or not. When the detection time is judged to have elapsed (Yes at Step S109), the image reception processing proceeds to Step S110. At Step S110, the medical image data is read from the image data storage section 32 by the suspicious region candidate detecting section 34, and the priority information is read from the header area of the medical image data. Then, the detection of the suspicious region candidates is started in descending order of the priority of the medical image data.

Next, when the detection of the suspicious region candidates has ended, the image reception processing proceeds to Step S111.

At Step S111, the communication section 31 transmits the detection result of the suspicious region candidates of the medical image data the detection of which has ended to the output apparatus 90 together with the medical image data.

The output apparatus 90 outputs the received medical image data and the detection result of the suspicious region candidates of the medical image data.

As described above, the communication load of the communication network N is monitored, and the detection time of suspicious region candidates is set. Then, the suspicious region candidate detecting apparatus 50 receives the medical image data being the detection object of the suspicious region candidates at a time zone in which the communication load is small on the basis of the monitoring result and the detection time. Consequently, the communication load of the communication network N can be reduced. Moreover, because the detection time can be set, the load of the suspicious region candidate detection can be dispersed. Consequently, improvement of image processing efficiency in the medical image processing system 200 can be achieved.

Moreover, because the priority of receiving medical image data is set in the suspicious region candidate detecting apparatus 50, the detection results of the suspicious region candidates can be obtained in descending order of the priority of the medical image data, and thereby improvement of diagnosis efficiency of a radiograph interpreting doctor can be achieved.

Moreover, when medical image data is received, the medical image data for the same examination is received in a lump. Consequently, the detection results of suspicious region candidates can be obtained per examination, and thereby improvement of diagnosis efficiency of a radiograph interpreting doctor can be achieved. Moreover, the suspicious region candidate detection processing performing the comparison of the detection results of suspicious region candidates per examination is enabled, and thereby improvement of detection accuracy can be expected.

Incidentally, the contents described with regard to the second embodiment are related to a preferable example of the medical image processing system 200 to which the present invention is applied, and the present invention is not limited to the contents.

For example, the network monitoring section 37, the priority setting section 38 and the time setting section 39 may be installed in another apparatus on the communication network N such as the medical image generating apparatus 20, the image storage apparatus 70 or the like. Thereby, the suspicious region candidate detecting apparatus 50 may obtain from the apparatus which installs the sections 37-39 therein the monitoring result of the communication network N by the network monitoring section 37, the information of the priority set by the priority setting section 38, and the information of the detection time set by the time setting section 39, and then the suspicious region candidate detecting apparatus 50 may receive medical image data.

Moreover, the suspicious region candidate detecting apparatus 50 comprises the reception history storage section 41. However, the present invention is not limited to this. The reception history storage section may be provided in another apparatus on the communication network N to manage the reception history information.

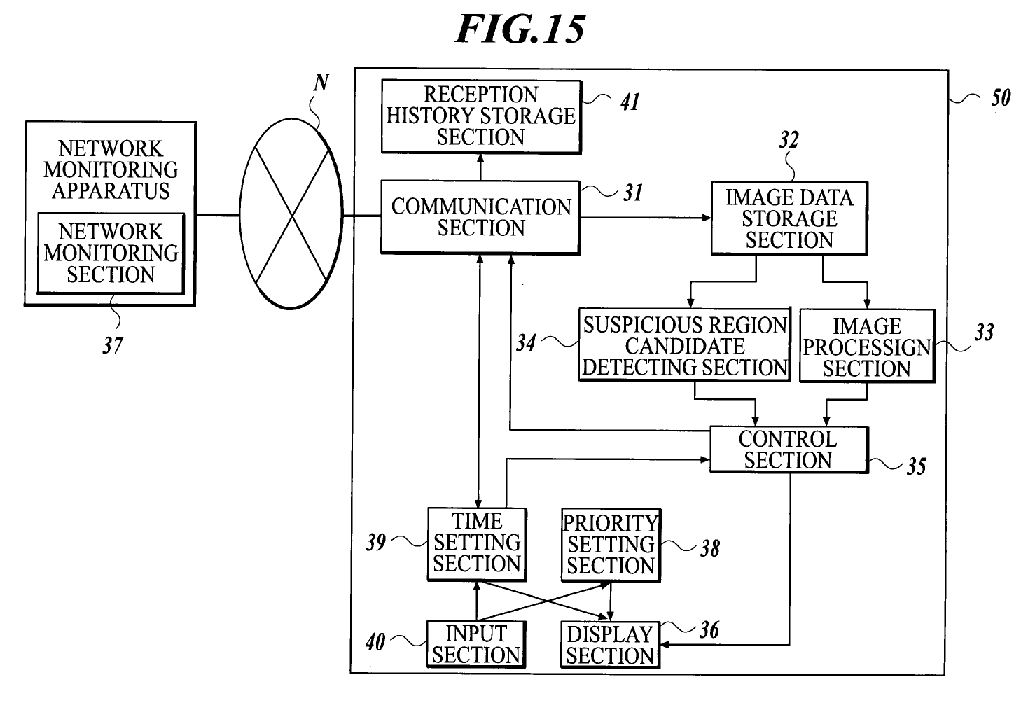

Moreover, the suspicious region candidate detecting apparatus 50 comprises the network monitoring section 37 in the above description. However, as shown in FIG. 15, the network monitoring section 37 may be installed in an information processing apparatus such as a personal computer equipped with a communication section, a mobile telephone, a PDA or the like, and the information processing apparatus may be installed in a medical image processing system as the network monitoring apparatus.

Moreover, the setting screen 182 for setting detection times is configured to enable to input the dates of the detection times directly for specification. However, the input of the dates is not limited to the above method. For example, the detection time may be suitably set in a time zone selected by the time setting section 39 after the selection of the time zone among roughly classified time zones such as the forenoon, the afternoon, the night and the like.

Moreover, in the above descriptions, the medical image generating apparatus 20 and the suspicious region candidate detecting apparatus 50 are described as separate apparatuses. However, as shown in FIG. 8, they may be configured to be an integrated apparatus including the image data generating function of the medical image generating apparatus 20, and the suspicious region candidate detecting function of the suspicious region candidate detecting apparatus 50.

In addition, the detailed configuration and the detailed operation of the medical image processing system 200 of the second embodiment also can be suitably changed without departing from the sprit of the present invention.

The entire disclosure of Japanese Patent Application No. 2003-14663 filed on Jan. 23, 2003 including specification, claims, drawings and summary are incorporated herein by reference in its entirety.

What is claimed is:

1. A medical image processing system comprising:
a medical image generating apparatus for generating medical image data of a radiographed subject;
a suspicious region candidate detecting apparatus for detecting a suspicious region candidate from the generated medical image data, the detecting apparatus being connected with the generating apparatus through a communication network;
a network monitoring section for monitoring a communication load of the communication network; and
a time setting section for setting an image transmission time for transmitting the medical image data from the generating apparatus to the detecting apparatus on the basis of a monitoring result of the communication load,
wherein the generating apparatus transmits the medical image data to the detecting apparatus at the set image transmission time.

2. The system of claim 1, comprising:
a priority setting section for setting priority of transmitting the medical image data,
wherein the generating apparatus transmits the medical image data to the detecting apparatus according to the set priority at the set image transmission time.

3. The system of claim 1, wherein when the detecting apparatus has received the medical image data from the generating apparatus, the detecting apparatus starts to detect the suspicious region candidate on the received medical image data.

4. The system of claim 1, wherein the time setting section sets the image transmission time in a time zone in which the communication load is small on the basis of the monitoring result of the communication load.

5. The system of claim 1, wherein the generating apparatus transmits all the medical image data belonging to the same examination.

6. The system of claim 1, comprising a transmission history storage section for storing information of a transmission history when the medical image data is transmitted from the generating apparatus.

7. The system of claim 1, wherein an output apparatus for outputting the medical image data about which the detection of the suspicious region candidate by the detecting apparatus has ended and a detection result of the suspicious region candidate is connected to the communication network.

8. The system of claim 7, wherein the output of the medical image data by the output apparatus is any one of output for a film, output for a storage medium and display output.

9. A medical image processing system comprising:
a medical image generating apparatus for generating medical image data of a radiographed subject;
a medical image receiving apparatus for receiving the generated medical image data, the receiving apparatus being connected with the generating apparatus through a communication network;
a network monitoring section for monitoring a communication load of the communication network; and
a time setting section for setting an image transmission time for transmitting the medical image data from the generating apparatus to the receiving apparatus on the basis of a monitoring result of the communication load,
wherein the generating apparatus transmits the medical image data to the receiving apparatus at the set image transmission time.

10. The system of claim 9, comprising:
a priority setting section for setting priority of transmitting the medical image data,
wherein the generating apparatus transmits the medical image data to the receiving apparatus at the set image transmission time according to the set priority.

11. The system of claim 9, wherein the time setting section sets the image transmission time in a time zone in which the communication load is small on the basis of the monitoring result of the communication load.

12. The system of claim 9, comprising a transmission history storage section for storing information of a transmission history when the medical image data is transmitted from the generating apparatus.

13. The system of claim 9, wherein the generating apparatus transmits all the medical image data belonging to the same examination.

14. The system of claim 9, wherein an output apparatus for outputting the medical image data is connected to the communication network.

15. The system of claim 14, wherein the output of the medical image data by the output apparatus is any one of output for a film, output for a storage medium and display output.

16. A medical image processing system comprising:
a medical image generating apparatus having a medical image generating section for generating medical image data of a radiographed subject, and a suspicious region candidate detecting section for detecting a suspicious region candidate from the medical image data;
a medical image receiving apparatus for receiving the medical image data about which the detection of the suspicious region candidate has ended, the receiving apparatus being connected with the generating apparatus through a communication network;
a network monitoring section for monitoring a communication load of the communication network; and
a time setting section for setting an image transmission time for transmitting the medical image data about which the detection of the suspicious region candidate by the detecting section has ended to the receiving apparatus on the basis of a monitoring result of the communication load,
wherein the generating apparatus transmits the medical image data about which the detection of the suspicious region candidate has ended to the receiving apparatus at the set image transmission time.

17. The system of claim 16, comprising:
a priority setting section for setting priority of transmitting the medical image data about which the detection of the suspicious region candidate has ended,
wherein the generating apparatus transmits the medical image data to the receiving apparatus according to the set priority at the set image transmission time.

18. The system of claim 16, wherein the time setting section sets the image transmission time in a time zone in which the communication load is small on the basis of the monitoring result of the communication load.

19. The system of claim 16, wherein the detecting section starts to detect the suspicious region candidate on the medical image data immediately after the medical image data is generated.

20. The system of claim 16, comprising a reception history storage section for storing information of a reception history when the medical image data is received from the generating apparatus.

21. The system of claim 16, wherein the generating apparatus transmits all the medical image data belonging to the same examination.

22. The system of claim 16, wherein an output apparatus for outputting the medical image data about which the detection of the suspicious region candidate by the suspicious region candidate detecting section has ended and a detection result of the suspicious region candidate is connected to the communication network.

23. The system of claim 22, wherein the output of the medical image data by the output apparatus is any one of output for a film, output for a storage medium and display output.

24. A medical image processing system comprising:
a suspicious region candidate detecting apparatus for detecting a suspicious region candidate from medical image data of a radiographed subject;
a medical image transmitting apparatus for transmitting the medical image data of a suspicious region candidate detection object to the detecting apparatus, the transmitting apparatus being connected with the detecting apparatus through a communication network;
a network monitoring section for monitoring a communication load of the communication network; and
a time setting section for setting a detection time for detecting the suspicious region candidate from the medical image data,
wherein the detecting apparatus receives the medical image data from the transmitting apparatus and detects the suspicious region candidate on the basis of a monitoring result of the communication load and the set detection time.

25. The system of claim 24, comprising:
a priority setting section for setting priority of receiving the medical image data,
wherein the detecting apparatus receives the medical image data according to the set priority.

26. The system of claim 24, wherein the detection time set by the time setting section is a time for starting the detection of the suspicious region candidate.

27. The system of claim 24, wherein the detection time set by the time setting section is a time for ending the detection of the suspicious region candidate.

28. The system of claim 24, wherein the detecting apparatus receives the medical image data in a time zone in which the communication load is small on the basis of the monitoring result of the communication load.

29. The system of claim 24, wherein the detecting apparatus receives all the medical image data belonging to the same examination.

30. The system of claim 24, comprising a reception history storage section for storing information of a reception history when the medical image data is received from the transmitting apparatus.

31. The system of claim 24, wherein the detecting apparatus is an integrated apparatus with a medical image generating apparatus for generating the medical image data of the radiographed subject.

32. The system of claim 24, wherein an output apparatus for outputting the medical image data about which the detection of the suspicious region candidate has ended and a detection result of the suspicious region candidate is connected to the communication network.

33. The system of claim 32, wherein the output of the medical image data by the output apparatus is any one of output for a film, output for a storage medium and display output.
